(19) United States
(12) Patent Application Publication
(10) Pub. No.: US 2021/0206364 A1
(43) Pub. Date: Jul. 8, 2021

(54) METHOD FOR CONTROLLING EQUIPMENT OF A COCKPIT OF A VEHICLE AND RELATED DEVICES

(71) Applicant: FAURECIA SERVICES GROUPE, Nanterre (FR)

(72) Inventors: Souheil HADJ SAID, Nanterre (FR); Romain RICHARD, Nanterre (FR); Nicolas GORRITY, Nanterre (FR)

(21) Appl. No.: 17/140,097

(22) Filed: Jan. 3, 2021

(30) Foreign Application Priority Data
Jan. 3, 2020 (FR) FR 20 00029

(51) Int. Cl. B60W 10/30; G06F 3/16; B60H 1/00; B60Q 3/80; B60N 2/02

(52) U.S. Cl. CPC B60W 10/30; G06F 3/167; B60H 1/00757; B60W 2710/30; B60N 2/0244; B60W 2420/54; B60Q 3/80

(57) ABSTRACT

A method for controlling pieces of equipment of a passenger compartment of a vehicle from a sound signal, each piece of equipment preferably being chosen from the list consisting of a seat, lighting, a dashboard and a ventilation system. The method includes determining a category to which the sound signal supplied belongs, from a list of predefined categories, the categories being representative of the nature of the sound signal, assigning a class to the sound signal from a list of predefined classes associated with the determined category, the classes being a description of the sound produced by the sound signal when the sound signal is read, and the generation, depending on the class assigned to the sound signal, of at least one control signal to at least one piece of equipment in the passenger compartment.

This patent application claims the benefit of document FR 20 00029 filed on Jan. 3, 2020, which is hereby incorporated by reference.

### FIELD OF THE INVENTION

The present invention relates to a method of controlling pieces of equipment in a passenger compartment of a transport vehicle. The present invention also relates to an associated device. The present invention also relates to a transport vehicle comprising such a device.

### BACKGROUND

The use of media players such as screens and speakers in vehicle interiors, such as a motor vehicle or an aircraft, provides entertainment for a passenger of the vehicle. It is then possible for the passenger to view a video, listen to music, or even play a video game while traveling in the transport vehicle.

However, such media players are not always sufficient to entertain the passenger; the latter may for example be disturbed by noises outside the vehicle, noises coming from a vehicle engine or even by other passengers in the vehicle.

There are dedicated devices designed to increase user immersion through actions associated with music, such as mirror balls, or vibrating tablets. However, such devices are bulky.

In addition, such devices do not allow such an increase in user immersion regardless of the sound signal used. These devices are generally limited to interaction with a very limited number of sound signals, and moreover involve preconfiguring a synchronization of the actions with the sound signal.

There is a need for a device that takes up less space and makes it possible to increase the passenger's immersion.

### SUMMARY

To this end, a method is proposed for controlling pieces of equipment in a vehicle interior from a sound signal, the piece of equipment preferably being chosen from the list consisting of a seat, lighting, a dashboard, and a ventilation system. The method comprises determining a category to which the sound signal supplied belongs from a list of predefined categories, the categories being representative of the nature of the sound signal, assigning a class to the sound signal from a list of predefined classes associated with the determined category, the classes being a description of the sound produced by the sound signal when the sound signal is read, and the generation, as a function of the class assigned to the sound signal, of at least one control signal intended for at least one piece of equipment in the passenger compartment.

Such a method makes it possible to associate the sound signal of the passenger compartment equipment controls, which increases the passenger's immersion and further entertains them.

According to particular embodiments, the control method comprises one or more of the following characteristics, taken in isolation or in any technically feasible combination:
the determination of the category of the sound signal comprises the determination of properties of the sound signal, and for each category of the list of predefined categories, the calculation of a score representative of the probability that the sound signal belongs to said category from the properties of the sound signal determined, to obtain a score calculated for each category, the calculation of the probability being implemented by a first calculation unit implementing a support vector machine, the determined category being the category whose calculated probability is the greater.
assigning the class to the sound signal comprises converting the sound signal into a spectrogram of the sound signal, to obtain a spectrogram, and for each class of the list of predefined classes associated with the category of the sound signal, the calculation of the probability that the sound signal belongs to said class from the spectrogram obtained, to obtain a calculated probability for each class, the calculation of the class probabilities being implemented by a second calculation unit implementing several distinct neural networks: a first network of neurons, such as a convolutional neural network, and for a predefined list of categories for a plurality of categories, a respective second neural network, such as a recurrent neural network, the assigned class being the class whose calculated probability is the greater.
the first neural network is suitable for transforming the spectrogram of the sound signal obtained into a vector of properties extracted from the sound signal and each second neural network is suitable for converting the vector of extracted properties obtained by the first neural network into probability, for each class of the list of predefined classes associated with the category of the sound signal, that the sound signal belongs to said class.
the steps of determination, assignment and generation are carried out synchronously with the reading of the sound signal.

The present description also relates to a device for controlling pieces of equipment in a vehicle passenger compartment, from a sound signal, the piece of equipment preferably being chosen from the list consisting of a seat, lighting, a dashboard, and a ventilation system. The control device is suitable for determining a category to which the sound signal supplied belongs from a list of predefined categories, the categories being representative of the nature of the sound signal, assigning a class to the sound signal from a list of predefined classes associated with the determined category, the classes being a description of the sound produced by the sound signal when the sound signal is read, and generating, depending on the class assigned to the sound signal, at least one control signal intended for at least one piece of passenger compartment equipment.

The present description also relates to a transport vehicle comprising a control device as defined above.

This description also relates to a computer program product comprising software instructions which, when executed by a computer, implement a control method as defined above.

The present description also relates to a computer-readable medium on which is stored a computer program comprising program instructions, the computer program being loadable on a data processing unit and designed to cause the implementation of a control method as defined above when the computer program is implemented on the data processing unit.

### BRIEF DESCRIPTION OF THE DRAWINGS

Other characteristics and advantages of the invention will become apparent upon reading the following description of embodiments of the invention, given by way of example only and with reference to the following drawings:

FIG. 1, a schematic view of an example of a vehicle, and

FIG. 2, a flowchart of an example of the implementation of an evaluation method.

### DETAILED DESCRIPTION

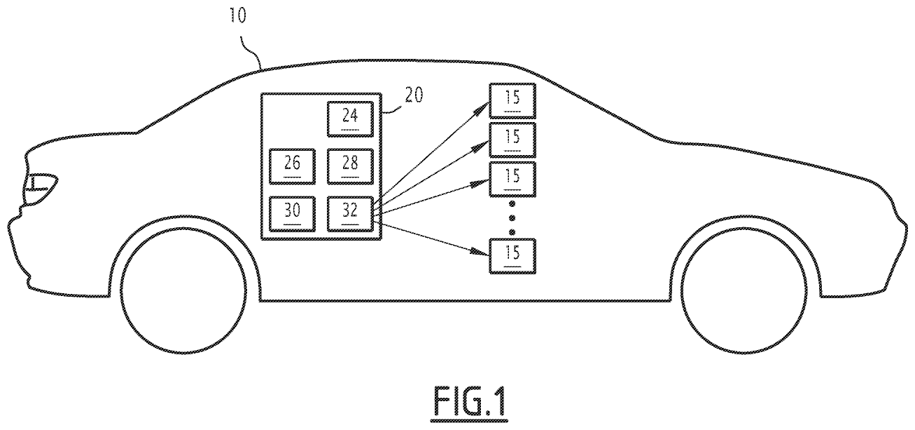

A transport vehicle 10, simply called vehicle in what follows, is shown in FIG. 1.

The vehicle 10 is, for example, a motor vehicle, or alternatively, an aircraft, or even any other type of vehicle transporting passengers, such as a car, a bus, a train, an airplane, or a truck.

The vehicle 10 comprises a passenger compartment comprising a plurality of pieces of equipment 15 and a control device 20.

Passenger compartment equipment is understood to mean any passenger compartment equipment that may be electronically controlled.

Each piece of equipment 15 is an actuator of the passenger compartment.

For example, the piece of equipment 15 is chosen from the list consisting of a seat, lighting, dashboard and ventilation system.

The control device 20 is designed to control the piece of equipment 15 from a sound signal provided.

For example, the sound signal may be the audio content of a video, music, or even a video game.

According to the example described, the sound signal is comprised in a database stored in a memory of the control device 20. Such a database is often referred to as a playlist. The memory storing the database is integrated in the vehicle 10 or is removable.

Alternatively, the sound signal may be stored in a memory of an electronic device, such as a computer, and the control device 20 is able to obtain the sound signal via a wireless connection, such as a Bluetooth connection.

Alternatively, the sound signal may be obtained using a sensor, in particular a microphone.

The control device 20 comprises a determination unit 24, a first calculation unit 26, a conversion unit 28, a second calculation unit 30 and a generation unit 32.

As specific examples, the controller comprises a single-core or multicore processor (such as a central processing unit (CPU), graphics processing unit (GPU), microcontroller, a digital signal processor (DSP), a programmable logic circuit (such as an application specific integrated circuit (ASIC), a field programmable gate array (FPGA), a programmable logic device (PLD) and programmable logic arrays (PLA), a status machine, a logic gate, and discrete hardware components.

For example, the control device 20 may be in the form of a computer program product comprising a memory and a processor associated with the memory, not shown. The determination unit 24, the first calculation unit 26, the conversion unit 28, the second calculation unit 30 and the generation unit 32 are then each produced in the form of software, or of a software brick executable by the processor. The memory is then able to store software for determining properties of the sound signal, a first software program for calculating, for each category, a score representative of the category probability of the sound signal, software for converting the sound signal into a spectrogram of the sound signal, a second software program for calculating class probabilities of the sound signal and software for generating a control signal.

When the control device 20 is produced in the form of a computer program product, it is also capable of being recorded on a medium, not shown, which may be read by computer. The computer readable medium may be, for example, a medium capable of storing electronic instructions and of being coupled to a bus of a computer system.

By way of example, the readable information medium is a floppy disk, an optical disk, a CD-ROM, a magneto-optical disk, a ROM memory, a RAM memory, an EPROM memory, a EEPROM memory, a magnetic card or an optical card.

The determination unit 24 is designed to determine properties of the sound signal.

More specifically, the determination unit 24 is designed to determine the properties of a plurality of segments of the sound signal, all of the segments preferably forming the sound signal.

Preferably, each segment of the sound signal has the same predefined duration, for example a duration of one second.

The properties of the sound signal are characteristic values of the sound signal and may be calculated from the sound signal.

The properties of the sound signal are, for example, the rate of change of sign of the sound signal, short term energy, short term energy entropy, centroid and spectral spread, spectral entropy, the spectral flux, the spectral attenuation, the Mel-Frequency Cepstral Coefficients (MFCC), and properties of the impulse response of the sound signal.

The rate of sign change is the rate at which the sound signal changes from a negative value to a positive value and vice versa.

Short-term energy is the energy calculated over a short period Ts, for example equal to 50 milliseconds.

The short-term energy entropy is the entropy calculated over the short period Ts.

The spectral centroid is the center of gravity of a spectrum. It is calculated from the weighted average of the frequencies in the sound signal.

The spectral spread is the standard deviation of the spectrum considering the spectral centroid as the average.

The spectral flux is the quadratic difference between the normalized intensities of the spectra of two successive frames of period Ts.

Spectral attenuation is the frequency below which 90% of the spectrum distribution is concentrated.

The determination unit 24 is furthermore able to supply the properties of each segment of the sound signal to the first calculation unit 26.

The first calculation unit 26 is designed to calculate, for each category of a predefined category list, the probability that the sound signal belongs to the category from the properties of the sound signal, so as to obtain a calculated probability for each category.

More specifically, the first calculation unit 26 is designed to calculate the scores for each category of each segment of the sound signal, from the properties of the segment.

According to the example described, the list of predefined categories comprises at least one of the following categories: lyrics, music, and sound event.

A sound signal belonging to the “words” category is a sound signal comprising dialogue, for example dialogue between characters.

A sound signal belonging to the “music” category is a sound signal comprising mainly musical content.

A sound signal belonging to the “sound event” category is a sound signal comprising a specific sound, for example emitted by an object. Typically, a set of sound events is provided to the first calculation unit 26 to define the category “sound event”.

More generally, each predefined category is representative of the nature of the sound signal.

According to the example described, the first calculation unit 26 is designed to implement a support vector machine (SVM).

A support vector machine is a supervised learning model intended to solve problems of discrimination and regression. From a set of learning samples, each identified as belonging to a category. The support vector machine is a model for assigning new samples to one of the categories, via a non-probabilistic binary linear classification.

Before being implemented by the first calculation unit 26, the support vector machine is previously trained on a database of sound signals annotated by a supervisor.

A media vector machine input variable is a vector containing the properties of the sound signal. Support vector machine output variables are the scores for each category in the list of predefined categories.

For example, after the scores are calculated, all scores have a negative value except one. The category of the segment is then considered to be the category whose score has a positive value.

The conversion unit 28 is designed to convert the sound signal to a spectrogram of the sound signal.

The spectrogram is a visual representation of the evolution of the power spectrum of the sound signal over time.

More specifically, the conversion unit 28 is designed to convert each segment of the sound signal into a spectrogram.

According to the example described, each spectrogram is a Mel spectrogram, i.e. a spectrogram whose frequency bands are logarithmically spaced on the Mel scale.

The Mel scale is a scale whose unit is the Mel. Mel is related to Hertz by a relationship established by experiments based on human hearing.

The conversion unit 28 is furthermore able to supply the spectrograms of each segment of the sound signal to the second calculation unit 30.

The second calculation unit 30 is designed to calculate, for each class of a predefined class list associated with the category of the sound signal, the probability that the sound signal belongs to the class of the obtained spectrogram.

More specifically, the second calculation unit 30 is designed to calculate the probabilities for each class of series of a predetermined number of consecutive segments of the same category, for example of series of ten consecutive segments of the same category. By definition, a class is associated with a category in the sense that the class clarifies the information that the sound signal belongs to the category.

The class is a description of the sound produced by the sound signal when playing the sound signal.

According to the case, the description is objective or subjective.

As examples of objective description, the list of predefined classes associated with a sound event includes classes corresponding to different types of recognizable sound events, such as an explosion, a gunshot, a train sound, or even a ship's sound.

As examples of subjective description, the predefined class list associated with a piece of music comprises at least one of the following classes: happy music, funny music, sad music, soft music, exciting music, angry music, and scary music. Such a description is an emotional type description. A classification into such attributes is often referred to as the “mood classification”.

As a variant, it is possible to mix subjective and objective description classes.

The second calculation unit 30 is designed to implement a first neural network R1 and, for each category of the predefined list of categories, a second neural network R2.

An input variable of the first neural network R1 is the spectrogram of the sound signal. An output variable of the first neural network R1 is a vector of properties extracted from the sound signal.

More specifically, the input variable of the first neural network R1 is the spectrogram of a segment of the sound signal, and the output variable of the first neural network R1 is the vector of properties extracted from the segment.

According to the example described, the first neural network R1 is a Convolutional Neural Network (CNN).

A convolutional neural network is a neural network comprising a set of layers, at least one of the layers using a convolution operation.

The first neural network R1 is previously trained on a database of spectrograms, for example a database of two million samples. For example, the database comprises samples belonging to one of the three categories “lyrics”, “music”, and “sound event” and to one class among more than five hundred different classes, each of the classes being associated with one of the three categories.

According to the example described, each second neural network R2 has the same architecture, in the sense that each second neural network R2 implements the same operations.

According to the example described, each second neural network R2 is a Recurrent Neural Network (RNN).

A recurrent neural network is a network of neurons made up of interconnected units interacting non-linearly and for which there is at least one cycle in the structure. The units are connected by arcs, which have a weight. The output of a unit is a non-linear combination of its inputs.

More specifically, each second neural network R2 is an LSTM network (Long Short-Term Memory).

An LSTM network is a recurrent neural network, each unit of which comprises an internal memory driven by control gates.

Alternatively, each second neural network R2 is another type of neural network capable of calculating probabilities for each class of the sound signal, such as a GRU network (Gated Recurrent Unit), or a DBoF network (Deep Bag of Frames).

According to a more elaborate variant, the second neural networks R2 are different according to the classes considered.

Nevertheless, the parameters of each second neural network R2, such as the weight of each unit of the second neural network R2 and its outputs, are different and are previously defined according to the category associated with the second neural network R2 and to the classes of the list of classes associated with the category.

An input variable of the second neural networks R2 is the vector of extracted properties obtained, while output variables of the second neural networks R2 are the probabilities for each class associated with the category of the sound signal, for each class of the list of predefined classes associated with the sound signal category.

More specifically, the second neural networks R2 are suitable for converting the vector of extracted properties obtained by the first neural network into probability, for each class of the list of predefined classes associated with the category of the sound signal that the sound signal belongs to said class.

Each second neural network R2 is previously trained on a database of vectors of extracted properties, according to its associated category.

We then consider that the class of a series of segments of the sound signal is the class whose calculated probability is the greatest.

The generation unit 32 is designed to generate, depending on the class of the sound signal, more specifically the series of segments of the sound signal, at least one control signal for pieces of equipment in the passenger compartment.

For example, for each category of the category list, at least one control signal for a piece of equipment in the passenger compartment is previously associated with each class of the predefined class list associated with the category, the generation unit 32 being designed to generate the at least one control signal associated with the class assigned to the sound signal.

In addition, the generation unit 32 is designed to generate control signals synchronously with the playback of the sound signal.

For example, the sound signal is played by an audio system in the passenger compartment or by an external electronic device providing the sound signal.

More specifically, when playing the sound signal, the generation unit 32 is designed to generate the control signal(s) associated with the class of a series of segments of the sound signal, at the time when the first segment of the series is read.

For example, the at least one control signal is chosen from a list of controls comprising at least one of the following controls: the lighting control, the control of a seat, the control of the display of the dashboard, and the ventilation system control.

For example, the lighting control is chosen from one of the following controls: the control of the brightness or the color of the lighting, and the control of a flashing of the lighting, the lighting being able to be arranged in particular in the ceiling, on the dashboard, on the door, on the central console, on a seat on a pillar, and/or on the floor.

The control of a passenger compartment seat is chosen from one of the following controls: control of the inclination of the seat, of a lateral and/or longitudinal displacement of the seat, of a rotation of the seat, of the seat heating, seat vibration, and control of a seat-integrated massage system when the seat is provided.

The control of the passenger compartment ventilation system is chosen from one of the following controls: control of the ventilation intensity, the temperature of the ventilated air, and ventilation by a selected scented air.

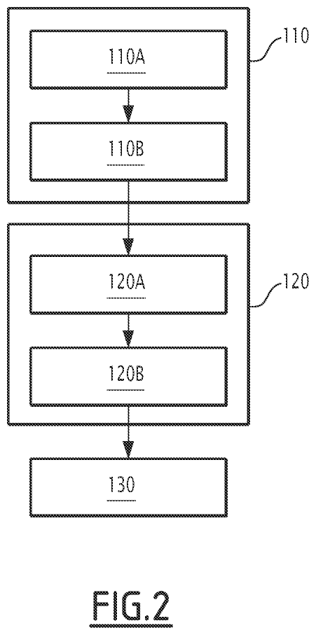

The operation of the control device 20 is now described with reference to FIG. 2, which illustrates an example of the implementation of a method for controlling orange lighting from a sound signal corresponding to joyful music.

The control method comprises a determination step 110, an allocation step 120 and a generation step 130.

The determination step 110 comprises a determination sub-step 110A and a first calculation sub-step 110B.

During the determination sub-step 110A, the determination unit 24 determines the properties of the sound signal and supplies them to the first calculation unit 26.

More specifically, the determination unit 24 determines the properties of each segment of the sound signal and supplies them to the first calculation unit 26.

During the first calculation sub-step 110B, the first calculation unit 26 calculates, for each category of the predefined list of categories, from the determined properties of the sound signal, the probability that the sound signal belongs to the category.

More specifically, the first calculation unit 26 calculates the probability for each category of each segment of the sound signal, on the basis of the determined properties of the segment.

For example, during the first computation sub-step 110B, for each segment of the sound signal, the support vector machine takes as its input the vector containing the properties of the segment, and outputs the score, for each category of the category list, the category determined at the end of the determination step 110 being the category for which the score is positive.

According to the example described, at the end of the determination step 110, the category whose calculated score having a positive value is the “music” category.

The assignment step 120 comprises a conversion substep 120A and a second computation substep 120B.

In the conversion substep 120A, the conversion unit 28 converts the sound signal into a spectrogram of the sound signal.

More specifically, the conversion unit 28 converts each segment of the sound signal into a spectrogram.

During the second calculation sub-step 120B, the second calculation unit 30 calculates, for each class of the predefined list of classes associated with the category of the sound signal, a probability that the sound signal belongs to the class from the spectrogram obtained.

More specifically, the second calculation unit 30 calculates the probability for each class of each series of ten consecutive segments of the same category.

For example, during the second calculation sub-step 120B, for each segment of the sound signal, the first neural network R1 takes as its input the spectrogram and gives as its output a vector of properties extracted from the segment, then, for each series of segments of the sound signal, the second neural network R2 takes as its input the property vectors extracted from each segment of the series and outputs the probability for each class of the class list associated with the category of segments of the series, the class assigned at the end of the assignment step 120 being the class for which the probability is the greatest.

For example, for the series of consecutive segments of the same category comprising a number of segments strictly less than ten, the class of the series is considered to be unknown, and the segments are not taken into account by the second calculation unit.

According to the example described, at the end of the assignment step 120, the class whose calculated probability is the greatest for the sound signal, is the class “happy music”.

During the generation step 130, the generation unit 32 generates, depending on the class of the sound signal, at least one control signal to the piece of equipment 15 in the passenger compartment.

The generated control signal is chosen according to a database of predefined actions according to the class assigned to the sound signal. For example, the generation of the control signal is based on a database containing the set of predefined actions and associating a plurality of actions with a class of sound signal.

According to the example described, the generation unit 32 generates an orange lighting control signal.

In addition, the generation unit 32 generates at least one control signal at the same time as the reading of the sound signal.

More specifically, the generation unit 32 generates the control signal(s) associated with the class assigned to a series of segments of the sound signal as the first segment of the series is read.

For example, a control signal associated with the class “ship noise” is the fresh air ventilation control.

As a variant, no class is associated with the “speech” category, so that the assignment 120 and generation 130 steps are not implemented when the determined category is the “speech” category.

Such a method therefore makes it possible to determine a category and a class of a sound signal, in order to control pieces of equipment in the passenger compartment. The method then makes it possible to associate a sound signal with controls related to the sound signal when it is read, in order to increase the immersion and therefore the entertainment of the passenger, the passenger then being surprised by the effect provided by the control of pieces of equipment, which makes the journey more pleasant and shorter.

In addition, the method is easy to implement and fast.

The method does not require any modification to the vehicle and is adaptable to all types of vehicles.

Furthermore, the proposed solution is not bulky, since it uses pieces of equipment already present in the vehicle.

The proposed solution is advantageous because it makes it possible to automatically detect, during reading, the different categories and classes associated with the sound signal and to control in real time the various pieces of equipment of the vehicle. This avoids having to calibrate, and pre-program various events in advance. This is particularly advantageous for non-linear and/or interactive streams, for example video games, where it is difficult or even impossible to program the events in advance, since they depend on the actions of the player.

1. Method for controlling pieces of equipment of a passenger compartment of a vehicle from a sound signal, the method comprising the steps of:
determining a category to which the sound signal supplied belongs from a list of predefined categories, the categories being representative of the nature of the sound signal,
assigning a class to the sound signal from a list of predefined classes associated with the determined category, the classes being a description of the sound produced by the sound signal when the sound signal is read, and
generating, depending on the class assigned to the sound signal, of at least one control signal intended for at least one piece of equipment in the passenger compartment.

2. Method according to claim 1, wherein the step of determining the category of the sound signal comprises:
determining the properties of the sound signal, and
for each category of the list of predefined categories, calculating a score representative of the probability that the sound signal belongs to said category from the determined properties of the sound signal, so as to obtain a score calculated for each category,
the step of calculating the probability being implemented by a first calculation unit implementing a support vector machine, and
the determined category being the category with the greatest calculated probability.

3. Method according to claim 1, wherein the step of assigning the class to the sound signal comprises:
converting the sound signal into a spectrogram of the sound signal, to obtain a spectrogram, and
for each class of the list of predefined classes associated with the category of the sound signal, calculating the probability that the sound signal belongs to said class from the spectrogram obtained, to obtain a probability calculated for each class,
the step of calculating the class probabilities being implemented by a second calculation unit implementing several distinct neural networks: a first neural network, such as a convolutional neural network, and for a plurality of categories of the list of predefined categories, a second respective neural network, such as a recurrent neural network, and
the assigned class being the class with the greatest calculated probability.

4. Method according to claim 3, wherein the first neural network is configured to transform the spectrogram of the sound signal obtained into a vector of properties extracted from the sound signal and wherein each second neural network is configured to convert the vector of extracted properties obtained, in a probability by the first neural network, the probability being the probability that the sound signal belongs to said class for each class of the list of predefined classes associated with the category of the sound signal.

5. Method according to claim 1, wherein the steps of determining, assigning and generating are performed in synchronization with the playback of the sound signal.

6. Method according to claim 1, wherein each piece of equipment is chosen from the list consisting of a seat, lighting, a dashboard, and a ventilation system.

7. Control device of pieces of equipment of a passenger compartment of a vehicle, from a sound signal, the control device being configured to:
determine a category to which the sound signal supplied belongs, from a list of predefined categories, the categories being representative of the nature of the sound signal,
assign a class to the sound signal from a list of predefined classes associated with the determined category, the classes being a description of the sound produced by the sound signal when the sound signal is read, and
generate, depending on the class assigned to the sound signal, at least one control signal intended for at least one piece of equipment in the passenger compartment.

8. Control device according to claim 7, wherein each piece of equipment is chosen from the list consisting of a seat, lighting, a dashboard, and a ventilation system.

9. Vehicle comprising a passenger compartment comprising a plurality of pieces of equipment, and a control device of pieces of equipment, according to claim 7.

10. A computer-readable medium on which is stored a computer program comprising program instructions, the computer program being loadable on a data processing unit and designed to cause the implementation of a method according to claim 1 when the computer program is implemented on the data processing unit.
